(19) United States
(12) Patent Application Publication
(10) Pub. No.: US 2025/0092862 A1
(43) Pub. Date: Mar. 20, 2025

(54) SHAPE MEMORY MATERIAL MEMBER ANCHOR

(71) Applicant: Toyota Motor Engineering & Manufacturing North America, Inc., Plano, TX (US)

(72) Inventors: Michael Paul Rowe, Pinckney, MI (US); Brian J. Pinkelman, Ann Arbor, MI (US); Yufei Zhu, Ypsilanti, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/468,029

(22) Filed: Sep. 15, 2023

(51) Int. Cl. F03G 7/06

(52) U.S. Cl. CPC F03G 7/06143; F03G 7/0616

(57) ABSTRACT

A system described herein relates to a shape memory material (SMM) wire anchor device. The system includes an eyelet including a surface and defining an aperture, a housing, and a shape memory material (SMM) member. An end portion of the SMM member extends through the housing, on the surface of the eyelet in a loop about the aperture, and back through the housing. The housing is deformed around the SMM member extending through the housing. The system also includes a fastener received in the aperture such that a portion of the SMM member is secured between the surface of the eyelet and the fastener.

### TECHNICAL FIELD

The subject matter described herein relates, in general, to shape memory material (SMM) actuators and, more particularly, to anchor systems for SMM actuators.

### BACKGROUND

Shape memory materials change shape when an activation input is provided to the material. When the activation input is discontinued, the shape memory material returns to its original shape. In some examples, shape memory materials are used in actuators where the change of shape of the shape memory material causes the actuator to achieve physical movement.

### SUMMARY

In one embodiment, a system is disclosed. The system includes an eyelet including a surface and defining an aperture, a housing, and an SMM member. An end portion of the SMM member extends through the housing, on the surface of the eyelet in a loop about the aperture, and back through the housing. The housing is deformed around the SMM member extending through the housing. The system also includes a fastener received in the aperture such that a portion of the SMM member is secured between the surface of the eyelet and the fastener.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a system for anchoring an SMM member.

FIG. 2 illustrates a cross-sectional view of the system for anchoring an SMM member, showing a first arrangement within a housing.

FIG. 3 illustrates a cross-sectional view of the system for anchoring an SMM member, showing a second arrangement within the housing.

FIG. 4 illustrates the system for anchoring an SMM member including an SMM actuator.

### DETAILED DESCRIPTION

A system associated with improving SMM actuator performance is disclosed herein. As previously described, SMM members can be implemented in actuators to generate physical movement. For example, in a liner actuator, the ends of an SMM member can be coupled to respective bodies that are biased to separate from one another. An activation input causes the SMM member to contract. The contraction causes the actuator to morph into an activated configuration. In the specific example of a linear actuator, the bodies coupled to either end of the SMM member can be drawn together as the SMM member contracts. While particular reference is made to SMM members incorporated into a linear actuator, various types of actuators can rely on SMM members to provide physical movement. As such, an SMM member can provide an actuation mechanism for various mechanical actuators.

However, in some cases, the force of the SMM member contraction can be strong enough to separate one or both ends of the SMM member from their respective attachment points to the actuator body. For example, the pulling force of an SMM wire can be from 150 megapascals (MPa) to about 400 MPa. This pulling force can be greater than the holding force of an attachment mechanism that operatively connects the SMM member to the actuator body. In this scenario, the SMM member can become detached from the bodies it is intended to move. When this separation occurs, the actuator can no longer provide its intended actuation function and becomes disabled. Accordingly, the present system can improve the reliability of the attachment between the SMM member and the actuator body to preclude this disabling separation.

Specifically, the present system includes an eyelet with an adjacent housing. An end portion of the SMM member extends through the housing, across the surface of the eyelet in a loop around an aperture of the eyelet, and back through the housing. A fastener is received in the aperture and secures the loop of the SMM member in place relative to the actuator. The fastener tightens against the surface to compress the SMM member between the fastener and the surface. The housing is then crushed, crimped, or otherwise deformed around the legs of the SMM member loops to prevent the SMM member from sliding or becoming separated as the activation input is applied and the SMM member contracts.

In one specific example, a metal sleeve is disposed around one of the legs of the loop within the housing such that the crushing, crimping, or other deformation of the housing also deforms the sleeve around the leg of the loop to further secure the SMM member in place relative to the actuator. The combined securement force of 1) the fastener, 2) the deformed housing, and 3) the deformed sleeve within the housing ensures the SMM member does not move relative to the actuator body in response to the activation input. In this way, the disclosed system improves SMM actuator performance by ensuring that the SMM member, which provides the actuation mechanism of the actuator, remains operatively connected to the actuator.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

It will also be appreciated that the term “operatively connected,” as used throughout this description, can include any type of connection, now known or later developed, including direct or indirect connections as well as connections without direct physical contact.

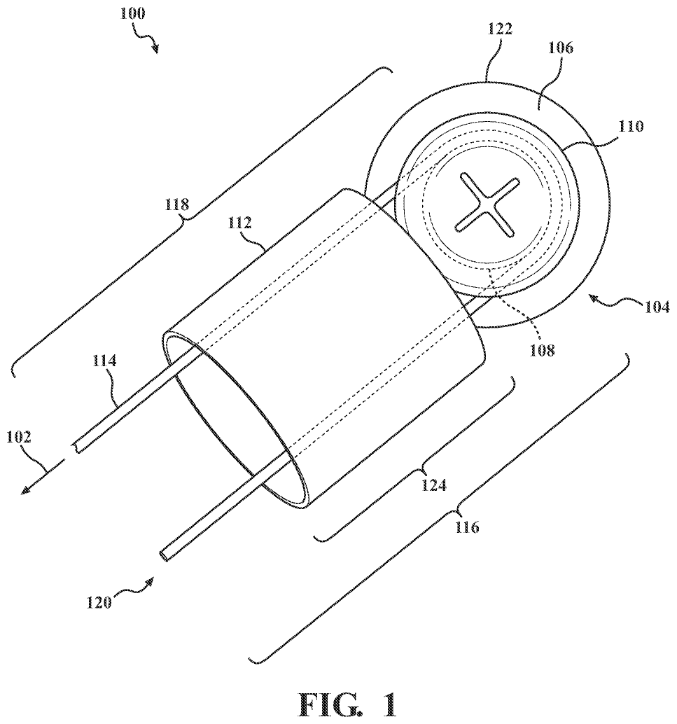

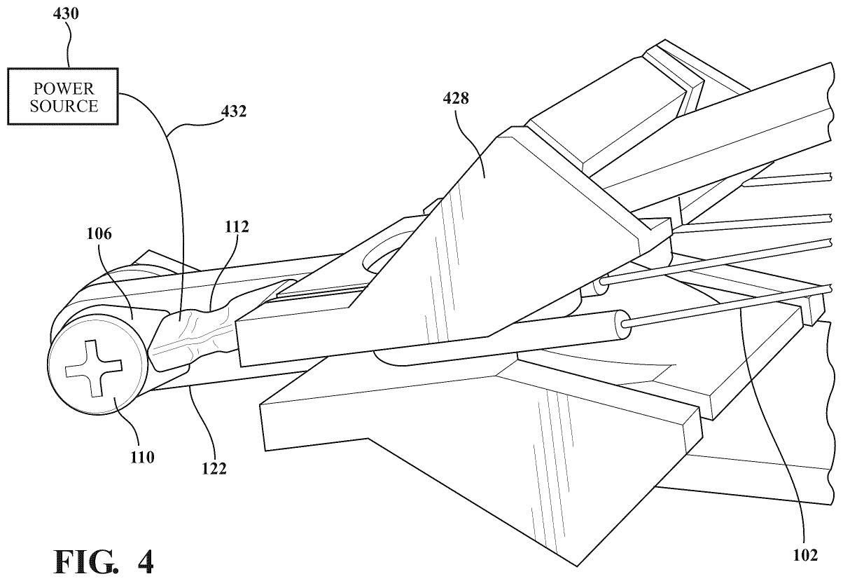

Turning to the figures, FIG. 1 illustrates an example of a system 100 for anchoring an SMM member 102. As described above, the system 100 can secure an SMM member 102 of an actuator to prevent separation of the SMM member 102 from the actuator body, which separation can defeat the intended purpose of the actuator. Note that FIG. 1 depicts the system 100 in a state where the housing 112 is not deformed and therefore does not secure the SMM member 102. FIG. 4, by comparison, depicts the deformed housing 112 which secures the SMM member 102.

As such, the system 100 can include an SMM member 102. As used in the present specification, the phrase “shape memory material” or “SMM” includes materials that change shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the SMM member 102 can be an SMM wire. As an example, the SMM member 102 can be a shape memory alloy wire. The wire contracts when an activation input (i.e., heat) is provided to the shape memory alloy wire. Shape memory alloy wires can be heated in any suitable manner, now known or later developed. For instance, shape memory alloy wires can be heated by the Joule effect by passing an electrical current through the wires. In some instances, arrangements can provide for cooling of the shape memory alloy wire, if desired, to facilitate the return of the wire to a non-activated configuration.

In operation, the SMM member 102 increases in temperature in response to an input. In some implementations, the SMM member 102 receives an electrical input, such as from a computing device and/or a power source. The computing device can be part of a system, such as an actuator control system. The SMM member 102 can heat up in response to the resistance of the member to electrical input. The SMM member 102, upon reaching a transition temperature A_{f}, changes from the first configuration to a second configuration. In this implementation, the SMM member 102 can contract. When used in an actuator, the SMM member 102 can apply a force on each of the bodies connected to either end of the SMM member 102. As a result, the bodies are drawn toward each other.

The SMM member 102 can have any suitable characteristics. For instance, the SMM member 102 can be a high-temperature SMM member 102 with austenite finish temperatures from about 80 degrees Celsius to about 110 degrees Celsius. When the SMM member 102 is a wire, the wire can have any suitable diameter. For instance, the wire can be from about 0.2 millimeters (mm) to about 0.7 mm, from about 0.3 mm to about 0.5 mm, or from about 0.375 mm to about 0.5 mm in diameter. In some arrangements, the SMM member 102 can have a stiffness of up to about 70 gigapascals. The pulling force of the SMM member 102 can be from about 150 MPa to about 400 MPa. The SMM member 102 can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the SMM member 102 can be configured to transform in phase, causing the SMM member 102 to be moved from a non-activated position to an activated position in about 3 seconds or less, about 2 seconds or less, about 1 second or less, or about 0.5 second or less.

The SMM member 102 can be made of any suitable shape memory material, now known or later developed. Different materials can be used to achieve various balances, characteristics, properties, and/or qualities. As an example, an SMM member 102 can include nickel-titanium (Ni—Ti, or nitinol). One example of a nickel-titanium shape memory alloy is FLEXINOL, which is available from Dynalloy, Inc., Irvine, California. As a further example, the SMM member 102 can be made of Cu—Al—Ni, Fe—Mn—Si, or Cu—Zn—Al.

The SMM member 102 can be configured to increase or decrease in length upon changing phase, for example, by being heated to a phase transition temperature T_{SMA}. Utilization of the intrinsic property of the SMM member 102 can be accomplished by using heat, for example, via the passing of an electric current through the SMM member 102 in order to provide heat generated by electrical resistance, in order to change a phase or crystal structure transformation (i.e., twinned martensite, detwinned martensite, and austenite) resulting in a lengthening or shortening the SMM member 102. In some implementations, during the phase change, the SMM member 102 can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials can be used in connection with the arrangements described herein. For example, other shape memory materials can be employed. Shape memory materials, a class of active materials, also sometimes referred to as smart materials, include materials or compositions that have the ability to remember their original shape, which can subsequently be recalled by applying an external stimulus, such as an activation signal.

While the shape memory material member 102 is described, in some implementations, as being a wire, it will be understood that the shape memory material member 102 is not limited to being a wire. Indeed, it is envisioned that suitable shape memory materials can be employed in a variety of other forms, such as sheets, plates, panels, strips, cables, tubes, or combinations thereof. In some arrangements, the shape memory material member 102 can include an insulating coating or an insulating sleeve over at least a portion of its length.

Returning to the system 100, the system 100 can include an eyelet 104. The eyelet 104 can have a surface 106 with an aperture 108 defined therein. The aperture 108 can be configured to receive a fastener 110, which can secure the SMM member 102. Specifically, and as depicted in FIG. 1, the SMM member 102 can loop around the aperture 108 and a shaft of the fastener 110. The fastener 110 can be tightened such that the SMM member 102 can be sandwiched between the surface 106 of the eyelet 104 and a portion (e.g., a head) of the fastener 110. In FIG. 1, the SMM member 102 and the aperture 108 are depicted in dashed lines to indicate their position underneath the fastener 110.

In an example, the surface 106 of the eyelet 104 can be substantially planer. In other examples, the surface 106 can be non-planar. For example, the surface 106 can be substantially curved. While FIG. 1 depicts a ring-shaped eyelet 104, the eyelet 104 can take a variety of shapes.

The eyelet 104 can be formed from a variety of materials, including a plastic material, a ceramic material, or any other type of material. In some examples, in addition to facilitating the mechanical securement of the SMM member 102, the eyelet 104 can also provide an electrical connection between 1) the SMM member 102 and 2) a power source through which the activation input is transmitted to the SMM member 102. For example, an electrical contact or trace can be operatively connected to the eyelet 104, which electrical contact/trace can be configured to deliver the activation input to the SMM member 102 by virtue of the physical contact between the eyelet 104 and the SMM member 102. In this example, the eyelet 104 can be formed of a conductive metallic material to facilitate the transmission of the electrical activation input.

The system 100 can also include the fastener 110, which can secure the SMM member 102. Specifically, the fastener 110 can be received in the aperture 108 such that an end portion 114 of the SMM member 102 is positioned between the fastener 110 and the surface 106 of the eyelet 104. The end portion 114 of the SMM member 102 can be secured between the fastener 110 and the surface 106 of the eyelet 104.

The fastener 110 can take a variety of forms. In one example, the fastener 110 can be a threaded shaft. The threads of the shaft can be configured to interact with corresponding threads on an inside diameter of the aperture 108, with threads on an actuator body, and/or with a retaining element (e.g., a nut) to secure the SMM member 102 to the surface 106 of the eyelet 104. That is, as the threads of the shaft and the corresponding threads in the aperture 108 and/or other engaging structure intermesh and draw the respective bodies towards one another, the SMM member 102 can be sandwiched therebetween. A contact force between the surface 106 of the eyelet 104, the SMM member 102, and the fastener 110 can retain the SMM member 102 in place and prevent slipping of the SMM member 102 and/or separation of the SMM member 102 from the actuator body to which it is attached. As such, the holding force of the system 100 is defined, at least in part, by the friction forces between the surface 106 of the eyelet 104, the head of the fastener 110, and the SMM member 102 loop.

While particular reference is made to a particular type of fastener 110, various types of fasteners 110 can be implemented in accordance with the principles described herein, including rivets, bolts, and the like. As such, the fastener 110 can provide one mechanism to secure the SMM member 102 during the operation of an associated actuator.

In an example, the fastener 110 can provide an electrical connection between 1) the SMM member 102 and 2) a power source through which the activation input is transmitted to the SMM member 102. For example, an electrical contact or trace can be operatively connected to the fastener 110, which electrical contact/trace can deliver the activation input to the SMM member 102 by virtue of physical contact between the fastener 110 and the SMM member 102. In this example, the fastener 110 can be formed of a conductive metallic material to facilitate the transmission of the electrical activation input.

The system 100 can also include a housing 112 that can be configured to further secure/anchor the SMM member 102. An end portion 114 of the SMM member 102 can extend through the housing 112, on the surface 106 of the eyelet 104 about the aperture 108, and back through the housing 112 as depicted in FIG. 1. As such, the SMM member 102 can form a loop, with the legs 116, 118 of the loop passing through the housing 112. As depicted in FIG. 1, the end portion 114 of the SMM member 102 includes an end 120, which end 120 can be located outside of the housing 112 while a portion 124 of the SMM member 102 extends within the housing 112. In an example, this end 120 is not connected to another body, i.e., it is a free end, and therefore does not activate to draw two bodies together. In this example, a second leg of the loop, referred to as an actuating leg 118, can extend to be used in an actuator. For instance, the actuating leg 118 can couple two bodies of an actuator together such that the bodies are drawn together upon activation. In another example, both legs 116, 118 of the loop can couple respective bodies of an actuator together and draw these respective bodies together upon activation. In either example, both legs 116, 118 can extend from the housing 112, such that the ends are not disposed within the housing 112.

As depicted in FIG. 1, the housing 112 can be adjacent to an outside surface 122 of the eyelet 104. For example, the housing 112 can be adjacent and/or tangential to the outside diameter of the eyelet 104. Specifically, the opening of the housing 112 can be adjacent and/or tangential to the outside surface 122 of the eyelet 104. The housing 112 can be adjacent to the eyelet 104 such that at least a portion of the interior surface (e.g., a floor) of the housing 112 is substantially flush with the surface 106 of the eyelet 104. A change in height between the housing 112 and the surface 106 of the eyelet 104 can present a stepped surface that could pinch the SMM member 102 upon deformation of the housing 112.

In some examples, the housing 112 can be operatively connected to the eyelet 104. As a specific example, the housing 112 can be affixed to the eyelet 104, with the opening of the housing 112 being adjacent and/or tangential to the outside surface 122 of the eyelet 104. In another specific example, the housing 112 and the eyelet 104 can be integrated with one another. That is, the housing 112 and the eyelet 104 can be a single component. As a specific example, the eyelet 104 and the housing 112 can be formed of a single body of material.

As described above, FIG. 1 depicts the housing 112 in an undeformed state. However, the housing 112 can be crushed, crimped, or otherwise deformed around the SMM member 102 extending therethrough to secure the SMM member 102 in place. Specifically, the housing 112 can be deformed against both legs 116, 118 of the SMM member 102 that pass therethrough. Friction between the deformed housing 112 and the lengths of the SMM member 102 disposed therein can prevent sliding of the SMM member 102 responsive to a contraction-inducing activation input. As such, the holding force of the system 100 can be defined, at least in part, by the friction forces between the housing 112 and two legs 116, 118 of the SMM member 102 loop.

The housing 112 can be formed of a material that can plastically deform without breaking or cracking. In some examples, the housing 112 can provide an electrical connection between 1) the SMM member 102 and 2) a power source through which the activation input is transmitted to the SMM member 102. For example, an electrical contact or trace can be operatively connected to the housing 112, which electrical contact/trace is configured to deliver the activation input to the SMM member 102 by virtue of physical contact between the housing 112 and the SMM member 102. In this example, the housing 112 can be formed of a conductive metallic material to facilitate the transmission of the electrical activation input. As a specific example, the housing 112 can be formed of a metallic material that can be crimped or otherwise compressed around the SMM member 102.

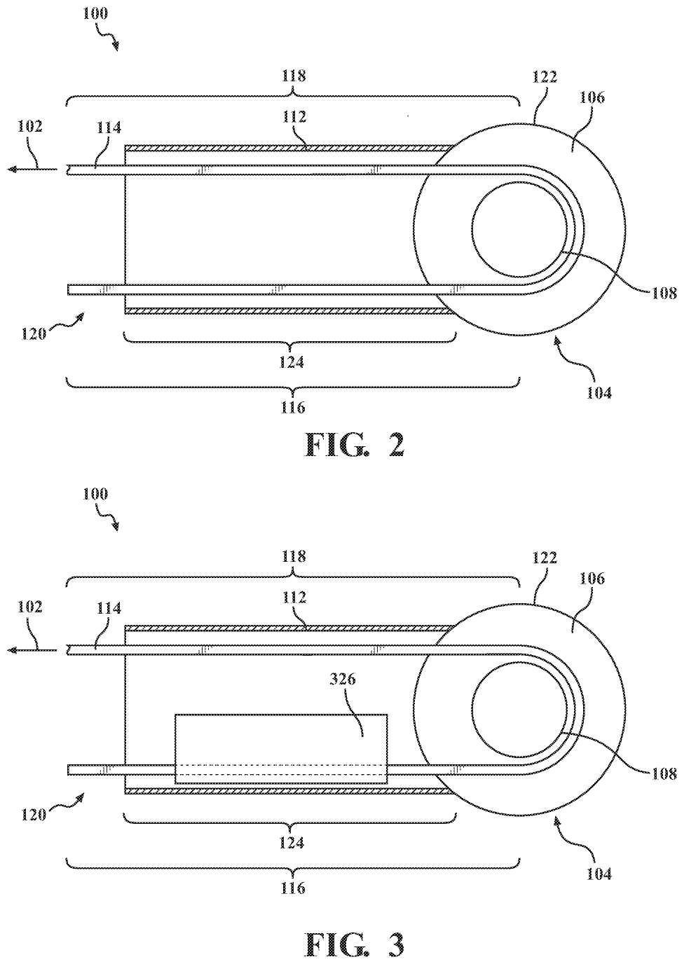

FIG. 2 illustrates a cross-sectional view of the system 100 for anchoring an SMM member 102, showing a first arrangement within the housing 112. Specifically, FIG. 2 depicts the loop that the SMM member 102 can form as it passes around the aperture 108 of the eyelet 104. The fastener 110 of the system 100 has been omitted from FIGS. 2 and 3 to facilitate visibility of the aperture 108 and the SMM member 102 looped on the surface of the eyelet 104. As depicted in FIG. 2, both legs 116, 118 of the SMM member 102 loop can extend through the housing 112. Doing so can maximize the contact area between the SMM member 102 and the housing 112. which maximizes the holding force of the housing 112.

FIG. 3 illustrates a cross-sectional view of the system 100 for anchoring an SMM member 102, showing a second arrangement within the housing 112. In the example depicted in FIG. 3, the system 100 can include additional components to further increase the holding force of the system 100. Specifically, in this example, the system 100 can include a sleeve 326 disposed within the housing 112. One portion 124 of the SMM member 102 that extends through the housing 112 can be received within the sleeve 326. Specifically, the portion 124 of the SMM member 102 that extends through the sleeve 326 can be the portion of the SMM member 102 that extends back through the housing 112 after extending on the surface 106 of the eyelet 104 in a loop about the aperture 108. As with the housing 112, the sleeve 326 can be deformed around the one portion 124 of the SMM member 102 that extends therethrough. The sleeve 326 can provide additional frictional force to prevent SMM member 102 slippage. As such, the holding force of the system 100 can be defined, at least in part, by the friction forces between the sleeve 326 and a respective leg 116 of the SMM member 102 loop. In one example, the sleeve 326 can be a separate component within the housing 112. In some arrangements, prior to deformation, the sleeve 326 and the housing 112 can be unattached to each other. In another example, the sleeve 326 can be integrated with the housing 112.

The sleeve 326 can be formed of the same or a different material from the housing 112 in which it resides. For example, the sleeve 326 can be formed of a metallic, plastic, or rubber material. In an example, the sleeve 326 can be formed of a rubber material to increase the friction and holding force of the system 100. In this example, on account of the sleeve 326 being formed of a rubber material, the electrical connection by which the activation input is provided to the SMM member 102 can be provided through the fastener 110 and/or eyelet 104. In the example where the electrical connection is provided by the housing 112, the sleeve 326 can be formed of a metallic material to facilitate transmission of the activation input.

FIG. 4 illustrates the system 100 for anchoring the SMM member 102. FIG. 4 also depicts a portion of an actuator 428 that can be acted upon by the SMM member 102. That is, the system 100 can include the actuator 428. The actuator 428 can include one or more SMM members 102 and can have any suitable form. One example of an actuator 428 will be described herein. However, it will be understood that this example is not intended to be limiting. Indeed, there are numerous actuator 428 designs that can include one or more SMM members 102.

As described above, the actuator 428 can have different bodies that are drawn together based on the action of an SMM member(s) 102. In one specific example, the actuator 428 can include a first outer body member attached to a second outer body member via the SMM member 102. As the SMM member 102 contracts, the outer body members can be brought closer together. As the activation input is removed, the SMM member 102 can expand to a non-activated configuration where the outer body members move away from each other. In this example, the SMM member 102 can be operatively connected to the body members of the actuator 428. However, the point of attachment between the actuator 428 outer body members and the SMM member 102 can fail when the holding force of the attachment point is less than the pulling force of the SMM member 102, causing the SMM member 102 to separate from the actuator 428 body members. However, the system 100 described herein can provide an interface with a holding force that reduces the likelihood of separation of the SMM member 102 from the actuator 428.

Specifically, FIG. 4 depicts the attachment of the SMM member 102 to the actuator 428 via the housing 112, eyelet 104, and fastener 110. As described above and as further depicted in FIG. 4, an end portion 114 of the SMM member 102 can extend through the housing 112, on the surface 106 of the eyelet 104 about the aperture 108, and back through the housing 112 as depicted in FIG. 1. As such, the SMM member 102 can form a loop, with the legs 116, 118 of the loop passing through the housing 112. FIG. 4 also depicts a deformed housing 112 which can compress against the legs 116, 118 of the SMM member 102 to prevent sliding of the SMM member 102.

In an example, the fastener 110 and/or the eyelet 104 can be operatively connected to the actuator 428 body member. In the example where the eyelet 104 and the housing 112 form an integrated component, the housing 112 can therefore be operatively connected to the actuator 428 body member. For example, the eyelet 104/housing 112 can be rigidly attached to the actuator 428 body member.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

1. A system, comprising:
an eyelet including a surface and defining an aperture;
a housing;
a shape memory material (SMM) member, an end portion of the SMM member extending through the housing, on the surface of the eyelet in a loop about the aperture, and back through the housing, the housing being deformed around and against the SMM member extending through the housing; and
a fastener received in the aperture such that a portion of the SMM member is secured between the surface of the eyelet and the fastener.

2. The system of claim 1, wherein the housing is adjacent to an outside surface of the eyelet.

3. The system of claim 1, wherein the housing is operatively connected to the eyelet.

4. The system of claim 1, wherein the SMM member is a shape memory alloy wire.

5. The system of claim 1, further including a sleeve disposed within the housing, wherein one portion of the SMM member that extends through the housing is received within the sleeve, and wherein the sleeve is deformed around the one portion of the SMM member that extends through the housing.

6. The system of claim 5, wherein the one portion of the SMM member that extends through the housing is a portion of the SMM member that extends back through the housing after extending on the surface of the eyelet in the loop about the aperture.

7. The system of claim 1, further comprising an actuator, the SMM member being a portion of the actuator, whereby, when an activation input is provided to the SMM member, the SMM member contracts, thereby causing the actuator to morph into an activated configuration.

8. The system of claim 7, wherein the housing further comprises an electrical contact to transmit the activation input from a power source to the SMM member.

9. The system of claim 7, wherein the fastener is operatively connected to an actuator body.

10. The system of claim 1, wherein the end portion of the SMM member includes an end, and wherein the end is located outside of the housing.

11. The system of claim 1, wherein the eyelet is external to the housing.

12. The system of claim 11, wherein an opening of the housing is adjacent and tangential to an outside surface of the eyelet.

13. The system of claim 12, wherein a portion of the interior surface of the housing is flush with the surface of the eyelet.
